(19) United States
(12) Patent Application Publication
(10) Pub. No.: US 2014/0362895 A1
(43) Pub. Date: Dec. 11, 2014

(54) METHOD, PROGRAM PRODUCT, AND TEST DEVICE FOR TESTING BIT ERROR RATE OF NETWORK MODULE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: SHENG-CUN ZHENG, Shenzhen (CN); HE-DONG LV, Shenzhen (CN); HONG-LIAN HUANG, Shenzhen (CN)

(21) Appl. No.: 14/295,743

(22) Filed: Jun. 4, 2014

(30) Foreign Application Priority Data
Jun. 6, 2013 (CN) 2013102220660

(51) Int. Cl. H04L 1/20

(52) U.S. Cl. CPC H04L 1/203
USPC 375/224

(57) ABSTRACT

A method for testing Bit Error Rate (BER) of a network module of a communication device includes executing a BER test program to begin a BER test; obtaining a current time and a test data of the BER test program; recording the current time and the test data corresponding to the current time in the test data recording document. The method also determines whether a time interval between the current time and a time when a last test data was recorded is greater than a predetermined value, and if so records a new time and a new test data.

### FIELD

The present disclosure relates to testing technologies, specifically to a test method and a test device for testing a Bit Error Rate (BER) of a network module of a communication device.

### BACKGROUND

For users of cellular telephones, cordless phones, wireless communications and data networks, pagers, and the like, network devices are part of their way of life. For these network devices, a crucial test is a BER test. The BER test determines the rate of faulty bits compared to transmitted bits. A network device with a high BER will sound poor (if it is a voice communications device) or perform poorly with a low data rate (if it is a data device).

The BER test is achieved by pushing a known data stream through the network device, typically via an antenna, and then comparing the data stream prior to a decoding stage with a copy of the known data stream. All errors, if any, are counted. If the BER for the device exceeds a predetermined amount of errors, the device is deemed to have failed the BER test. The BER test can also be performed on wired devices as well as wireless devices.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a communication device, according to an exemplary embodiment.

FIG. 2 is a block diagram showing a testing system used to test BER of a network module of the communication device of FIG. 1, according to an exemplary embodiment.

FIG. 3 is a flowchart of a method for testing Bit Error Rate (BER) of a network module of the communication device of FIG. 1, according to an exemplary embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive, or other suitable storage medium.

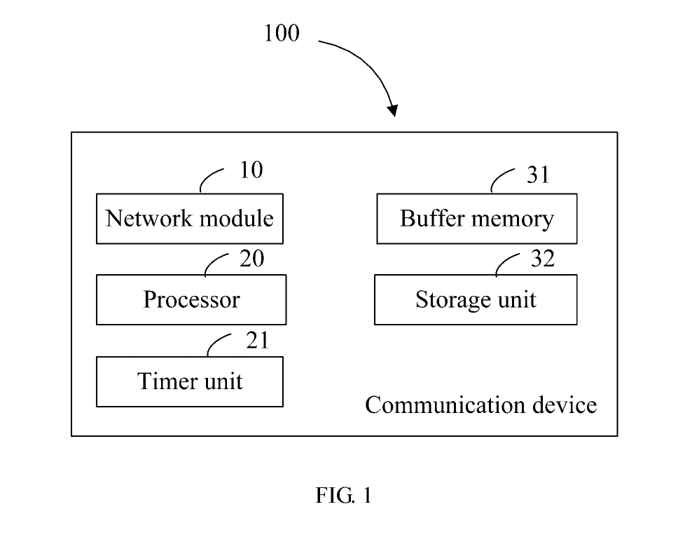

Referring to FIG. 1, a communication device 100 includes a network module 10, a processor 20, a timer unit 21, a buffer memory 31, and a storage unit 32. The storage unit 32 is configured to store a plurality of instructions of an operating system (OS), which when executed by the processor 20, causes the processor 20 to execute various operations.

A Bit Error Rat (BER) test program is also stored in the storage unit 32, the processor 20 executes the BER test program to test BER of the network module 10.

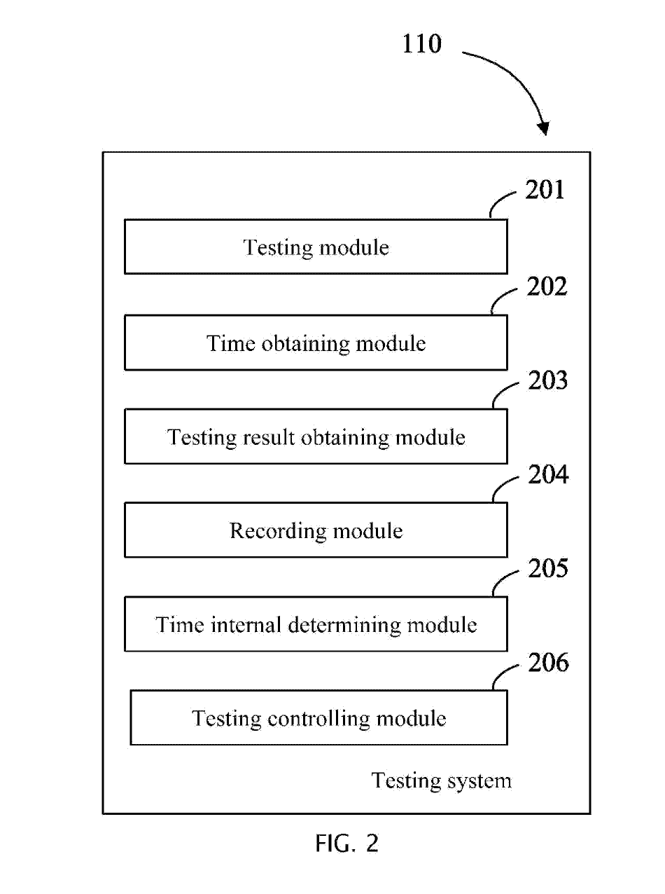

Referring to FIG. 2, a testing system 110 is used to test BER of the network module 10 of the communication device 100. The testing system 110 is executed on the processor 20 of the communication device 100.

The testing system 110 includes a testing module 201, a time obtaining module 202, a test data obtaining module 203, a recording module 204, a time internal determining module 205, and a testing controlling module 206.

The testing module 201 can include a BER test program executed on the processor 20 configured to test BER of the network module 10. The BER test program pushes a known data stream through the network device, compares the data stream prior to a decoding stage with a copy of the known data stream, and then records the error data stream in the buffer memory 31 and counts amount of error data stream. The BER test program further calculates the BER of the network module 10 according to the amount of error data stream and the amount of known data stream.

The time obtaining module 202 obtains a current time from the timer unit 21. The test data obtaining module 203 obtains a test data of the BER test program, the test data is a list of the error data stream. The recording module 204 generates a test data recording document, and records the current time and the test data corresponding to the current time in the test data recording document. The test data recording document is stored in the storage unit 32.

The time internal determining module 205 determines whether or not a time interval between the current time and a time when a last test data was recorded, is equal to or greater than a predetermined value. When the time interval between the current time and a time when a last test data was recorded is equal to or larger than the predetermined value, the time obtaining module 202 obtains a new time. The test data obtaining module 203 obtains a new test data corresponding to the new time, the recording module 204 records the new time and the new test data in the test data recording document.

The testing controlling module 206 is configured to determine whether testing module 201 completes the BER test, and generates a end signal when the BER test is completed.

In another embodiment, the testing system 110 is used in a specialized BER testing device, the BER testing device also includes a processor, a buffer memory, and a storage unit, the testing system 110 can be executed on the processor.

With such configuration, the testing system 110 records the test data periodically, even if the test process eventually breaks or crashes, the test data before the breakdown or crash can be preserved.

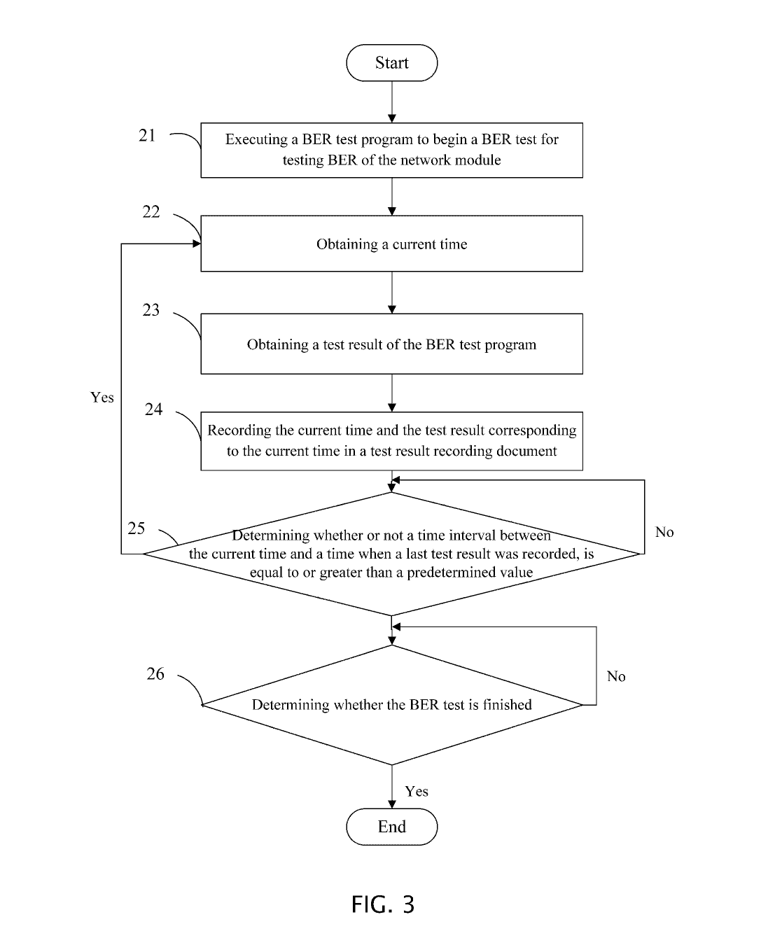

FIG. 3 is a flowchart of an example testing method for testing BER of a network module 10 of the communication device 100.

In block 21, executing a BER test program to begin a BER test for testing BER of the network module 10. The BER test program is executed on the processor 20 to begin a BER test for testing BER of the network module 10.

In block 22, obtaining a current time. The current time is obtained from the timer unit 21 of the communication device 100.

In block 23, obtaining a test data of the BER test program. The test data is a list of error data stream.

In block 24, generating a test data recording document, and recording the current time and the test data corresponding to the current time in the test data recording document. The test data recording document is stored in the storage unit 32.

In block 25, determining whether or not a time interval between the current time and the time when a last test data was recorded, is equal to or greater than a predetermined value; if yes, goes to block 22; if not, the method continues to 25.

The method further includes block 26, determining whether the BER test is finished; if yes, goes to end; if not, the method goes to 25.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A method for testing Bit Error Rate (BER) of a network module of a communication device, the method comprising:
a. executing a BER test program to begin a BER test for testing a BER of the network module;
b. obtaining a current time;
c. obtaining a test data of the BER test program;
d. recording the current time and the test data corresponding to the current time in a test data recording document; and
e. determining whether or not a time interval between the current time and a time when a last test data was recorded is equal to or greater than a predetermined value; if yes, goes to b; if no, continues to e.

2. The method as described in claim 1, further comprising determining whether the BER test is finished; if yes, goes to end; if no, goes to e.

3. A program product for testing Bit Error Rate (BER) of a network module of a communication device, the program product comprising:
a storing unit for recording the software instruments; and
the software instruments configured to execute the method for testing Bit Error Rate (BER) of a network module of a communication device, the method comprising:
a. executing a BER test program to begin a BER test for testing BER of the network module;
b. obtaining a current time;
c. obtaining a test data of the BER test program;
d. recording the current time and the test data corresponding to the current time in the test data recording document; and
e. determining whether or not a time interval between the current time and a time when a last test data was recorded is equal to or greater than a predetermined value; if yes, goes to b; if no, continues to e.

4. The program product as described in claim 3, further comprising determining whether the BER test is finished; if yes, goes to end; if no, goes to e.

5. A testing device for testing Bit Error Rate (BER) of a network module of a communication device, the testing device comprising:
a storing unit for recording the software instruments; and
the software instruments configured to execute the method for testing Bit Error Rate (BER) of a network module of a communication device, the method comprising:
a. executing a BER test program to begin a BER test for testing BER of the network module;
b. obtaining a current time;
c. obtaining a test data of the BER test program;
d. recording the current time and the test data corresponding to the current time in the test data recording document; and
e. determining whether or not a time interval between the current time and a time when a last test data was recorded is equal to or greater than a predetermined value; if yes, goes to b; if no, continues to e.

6. The testing device as described in claim 5, further comprising
determining whether the BER test is finished; if yes, goes to end; if no, goes to e.
